(19) United States
(12) Patent Application Publication
(10) Pub. No.: US 2015/0095498 A1
(43) Pub. Date: Apr. 2, 2015

(54) Allocating Bandwidth in a Network

(71) Applicants: Jean Tourrilhes, Mountain View, CA (US); Kevin Christopher Webb, San Diego, CA (US); Sujata Banerjee, Palo Alto, CA (US); Jeffrey Clifford Mogul, Menlo Park, CA (US); Puneet Sharma, Palo Alto, CA (US); Praveen Yalagandula, San Francisco, CA (US)

(72) Inventors: Jean Tourrilhes, Mountain View, CA (US); Kevin Christopher Webb, San Diego, CA (US); Sujata Banerjee, Palo Alto, CA (US); Jeffrey Clifford Mogul, Menlo Park, CA (US); Puneet Sharma, Palo Alto, CA (US); Praveen Yalagandula, San Francisco, CA (US)

(21) Appl. No.: 14/384,996

(22) PCT Filed: Mar. 14, 2012
(86) PCT No.: PCT/US2012/029109

§ 371 Date: Sep. 12, 2014

(51) Int. Cl. H04L 12/911; H04L 12/801

(52) U.S. Cl. CPC H04L 47/783; H04L 47/12
USPC 709/226

(57) ABSTRACT

Allocating bandwidth in a network (100) may include reducing initial bandwidth allocations for each tenant on a link (113) such that a sum of the bandwidth allocations is equal to or less than a capacity of the link and distributing a residual of the initial bandwidth allocations to at least one under-allocated link (114).

### BACKGROUND

Often, data centers house computing resources connected together in a data center network. Clients or “tenants” of a data center may rent usage of the data center's computing resources to avoid having to invest in their own resources. Often, a data center network has multiple tenants using its computing resources at the same time.

A controller in the data center may monitor the various computing resources of the data center's network to ensure that each computing resource is not overloaded by the tenants' traffic. In some data centers, rate limiters may be used to prevent the computing resources from becoming overwhelmed. Computing resources may be located behind switches that control traffic to and from each computing resource. Usually, the switches are connected to one another through links, which may be wireless links or physical media that carry the data center's traffic.

### BRIEF DESCRIPTION OF THE DRAWINGS

The accompanying drawings illustrate various examples of the principles described herein and are a part of the specification. The illustrated examples are merely examples and do not limit the scope of the claims.

FIG. 1 is a diagram of an illustrative network, according to principles described herein.

FIG. 2 is a diagram of an illustrative chart of bandwidth allocations, according to principles described herein.

FIG. 3 is a diagram of an illustrative chart of bandwidth allocations, according to principles described herein.

FIG. 4 is a diagram of an illustrative method for allocating bandwidth, according to principles described herein.

FIG. 5 is a diagram of an illustrative controller for allocating bandwidth, according to principles described herein.

FIG. 6 is a diagram of an illustrative flowchart for allocating bandwidth, according to principles described herein.

FIG. 7 is a diagram of an illustrative flowchart for allocating bandwidth, according to principles described herein.

### DETAILED DESCRIPTION

The present specification describes principles including, for example, a method for allocating bandwidth in a network such that links between the network's resources do not exceed their bandwidth capacity. Each tenant may be initially allocated bandwidth on links that carry each tenant's traffic between network switches. In many cases, multiple tenants may be allocated bandwidth on the same link at the same time. Examples of such a method may include reducing the initial bandwidth allocations for each tenant on a link such that a sum of the bandwidth allocations is less than a capacity of the link and distributing a residual of the initial bandwidth allocations to at least one under-allocated link.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described is included in at least that one example, but not necessarily in other examples.

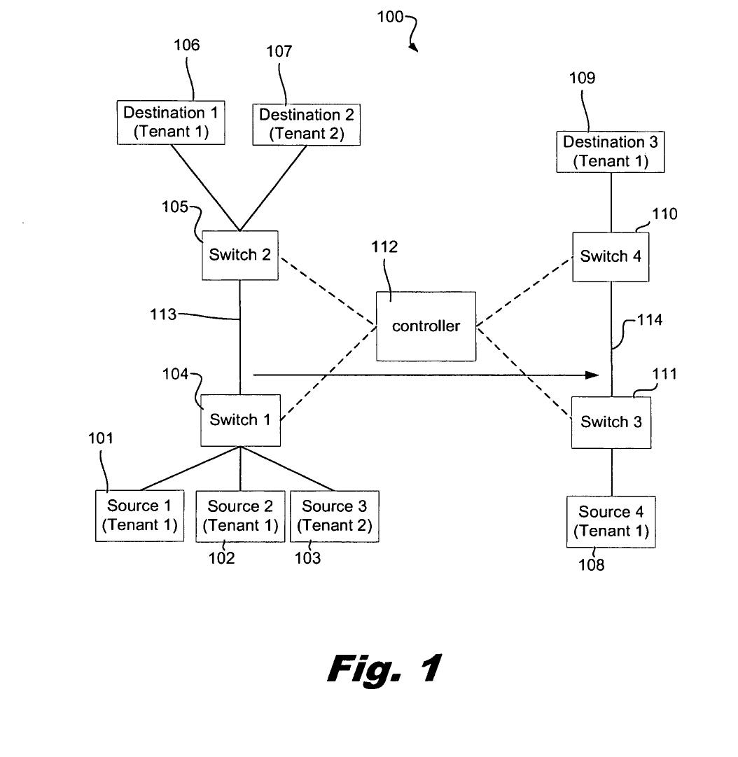

FIG. 1 is a diagram of an illustrative network (100), according to principles described herein. In this example, a first, second, and third traffic sources (101, 102, 103) send traffic through a plurality of switches (104, 105), to first and second network destinations (106, 107). Further, a fourth traffic source (108) may send traffic to another network destination (109) through another plurality of switches (110, 111). In this illustrated example, a first tenant is using the first, second, and fourth traffic sources (101, 102, 108), and a second tenant is using the third traffic source (103).

The controller (112) may be a network device that controls the switches and determines how traffic is routed. In some examples, the network is a data center network, and the traffic contains information for processing data within the network (100). Tenants may use the resources connected to the network to process data or perform some networking functions that are traditionally done by network devices. In some examples, the tenants are corporations, businesses, organizations, individuals, or combinations thereof that use resources on the network. In some examples, multiple tenants use multiple traffic sources, links, controllers, destinations, compute nodes, network devices, network programs, other network resources, or combinations thereof at the same time. The tenants may request that jobs be processed on the network, but the network controller itself controls the processing requested by the tenants. Further, the network may track and allocate resources on a per tenant basis.

A network destination may be a networked device that has a capability to perform a function of the network, such as processing information requested by the traffic sources. In some examples, the network (100) is a network type from the following non-exhaustive list, such as local area networks, wide area networks, wireless networks, virtual private networks, computer networks, telecommunication networks, peer to peer networks, data center networks, and combinations thereof.

In some examples, the controller orchestrates all or a portion of the devices in the network. In other examples, the network is a peer-to-peer network where controls of the network are distributed among multiple devices in the network (100).

In the example of FIG. 1, a first tenant utilizes the first and second traffic sources (101, 102) that send traffic to the first network destination (106). Both the first and the second traffic sources send their traffic to the first switch (104), which routes the traffic over a first link (113) to a second switch (105) that routes the traffic specific for the first tenant to the first network destination (106). However, in this example, the third traffic source (103) also sends information to the first switch (104) which also routes the traffic from the second traffic source (103) over the first link (113) towards the second switch (105). At the second switch (105), the traffic from the third traffic source (103) or the second tenant is routed towards the second network destination (107).

The network may have devices and/or mechanisms that prevent the network destinations from being overwhelmed by the traffic sources and/or tenants. However, some or all of the links of the network may also be susceptible to traffic demands that exceed their capacity. The controller may identify the tenants that are using and/or requesting to use the network. In some examples, the controller assigns each of the traffic sources at least one network destination to perform the function sought by the traffic sources. Also in some examples, the controller determines the route that the traffic takes to arrive at the assigned network destination.

In some examples, the controller (112) allocates an initial amount of bandwidth to each tenant on particular links of the network (100). In the example of FIG. 1, the controller (112) has made an initial bandwidth allocation on the first link (113) for the first tenant and a second bandwidth allocation for the second tenant also over the first link (113). In some examples, the sum of the initial bandwidth allocations is less than the capacity of the first link (113). However, in other examples, the sum of the first and second initial bandwidth allocations may be greater than the link's capacity. In such a situation, the controller (112) may reduce the initial bandwidth allocation such that the sum of these allocations is less than or equal to the link's capacity. The controller may also identify other available links in the network and allocate at least a portion of the residual bandwidth allocations to those available links.

In the example of FIG. 1, a residual of the bandwidth allocation is allocated to the second link (114). In this example, the second link (114) is not fully allocated and just the first tenant is allocated bandwidth on the second link (114). Since the first tenant is already allocated bandwidth over the second link (114), the controller may merely increase the first tenant's initial bandwidth over the second link (114) as the first tenant lost some of its bandwidth allocation over the first link.

In addition to identifying under-allocated links for residual allocations, the system may also identify uncongested links. In some examples, a congested link is a link that carries so many packets that the traffic on the link is affected adversely. For example, the packets may experience increased delays or interference. In some examples, packets get dropped. In some examples, the network specifies how a congested link should be managed following rules outlined in a network policy. In some examples, the network deems a link to be congested when the link's usage is approaching a threshold with a margin before the traffic on the link is adversely affected.

In some examples, the controller reduces both the bandwidth allocations for the first and the second tenants over the first link (113) by substantially the same amount or an amount substantially proportional to the initial bandwidth allocations. In such examples, the second tenant's residual bandwidth may also be allocated to another link in the network (100). In some examples, the second tenant's residual bandwidth allocation is allocated to an uncongested or under-allocated link of the network, another link to which the second tenant is already allocated bandwidth, another available link, or combinations thereof. In some examples, both the residual bandwidths of the first and second tenants are reallocated to the same available link. In other examples, the residual bandwidths are allocated to separate links. Further, in some examples, at least one of the bandwidth allocations is allocated to multiple available links.

Such an arrangement may be desirable to maximize the efficiency of the links (113, 114) and the overall network as a whole while still fairly allocating network resources to the tenants. A link may be underutilized when it is assigned less traffic demand than its bandwidth capacity. Underutilizing the links may increase the amount of networked resources needed to process the same amount of traffic.

In some examples, the first tenant is the first in time to be assigned bandwidth over the first link (113) and, as such, may enjoy the full usage of its bandwidth allocation without competition from other tenants. However, the second tenant may be allocated bandwidth over the first link (113) later in time, but still while the first tenant is continuing to use its allocation on the first link (113). This additional allocation may cause the total bandwidth to exceed the capacity of the first link (113). In such situations, the controller (112) may reduce the bandwidth of each of the tenants and reallocate the residual bandwidth allocations to under-allocated links on the network.

In some examples, a third tenant may also be allocated additional bandwidth on the first link (113). In such an example, the controller may further reduce the bandwidth allocations to each of the tenants and reallocate the new additional residual bandwidth allocations to under-allocated links on the network.

In some examples, one of the tenants may cease to send traffic or may reduce its demand for network resources. In such an example, the bandwidth allocations of the remaining tenants may be increased over the first link (113). Depending on the size of the initial bandwidth allocations, multiple tenants may operate together on a single link without exceeding the capacity of the link.

In some examples, the controller restricts bandwidth for just one of the tenants over the first link. Such an example may occur in a scenario where the first tenant already has bandwidth allocated over another link and that bandwidth may be increased to accommodate for the lost bandwidth over the original link.

A non-exhaustive list of factors that may affect how the controller reduces and redistributes the bandwidth may include an amount that the tenant is paying for usage of the network; the size of the job the network is processing for the tenant; historical usage of the network; a processing deadline; the amount of traffic sources, links, and/or network destinations being used by a tenant; a particular type of job being processed for the tenant; other factors; or combinations thereof.

In some examples, a network has a single controller that controls the bandwidth allocation for the entire network. In some examples, multiple controllers are used to allocate bandwidth within assigned regions of the network. Further, in some examples, a network may utilize multiple controllers that collectively allocate bandwidth throughout the entire network or within regions of the network through coordinating their efforts with each other.

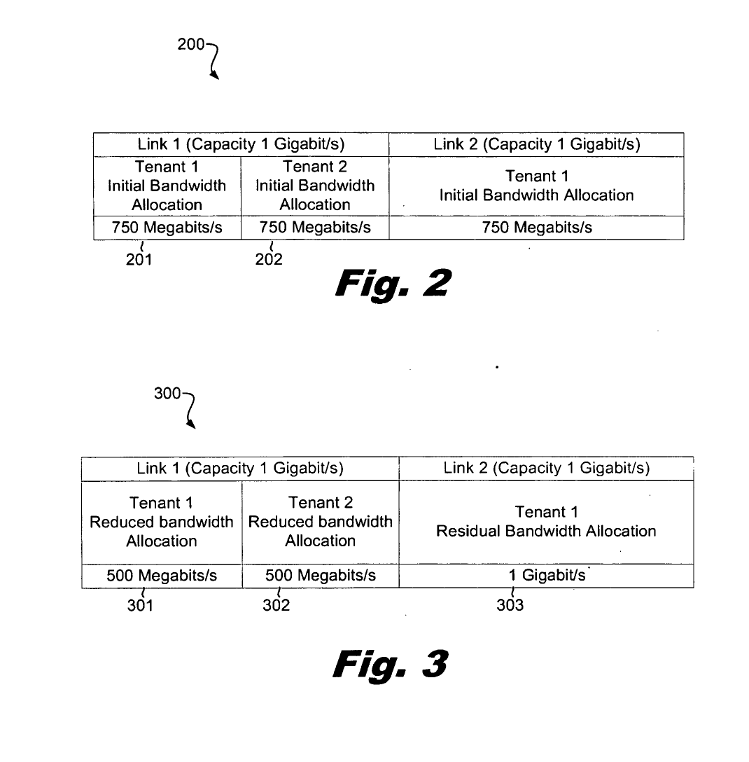

FIG. 2 is a diagram of an illustrative chart (200) of bandwidth allocations, according to principles described herein. In this example, a first link's capacity is one gigabit per second. A field (201) representing the bandwidth allocation for a first tenant indicates that the first tenant has a bandwidth allocation of 750 megabits per second. Another field (202) that represents the bandwidth allocation for a second tenant indicates that the second tenant also has a bandwidth allocation of 750 megabits per second on the same link.

In this example, the capacity of the first link is exceeded. Thus, the controller may reduce the bandwidth allocations for both links and identify an under-allocated link to redistribute the residual bandwidth allocations. In this example, a second link has a capacity of one gigabit per second. Just the first tenant is allocated bandwidth on second link and has a 750 megabits per second bandwidth allocation. Therefore, the second link may be under-allocated and capable to absorb a 250 megabits per second residual allocation.

As shown in the example of FIG. 3, the network restricts the bandwidth allocations of both the first and the second tenants on the first link to prevent exceeding its capacity. In this example, a field (301) that represents the reduced bandwidth allocation of the first tenant assigned to the first link indicates that the reduced bandwidth allocation is 500 megabits per second. Also, another field (302) that represents the reduced bandwidth allocation of the second tenant on the first link indicates that its reduced bandwidth allocation is also 500 megabits per second. Thus, the sum of the reduced bandwidth allocations of both tenants equals the bandwidth capacity of the first link. As a consequence, the first link is fully utilized.

For the second link, a third field (303) represents the bandwidth allocation for the first tenant indicating that its residual bandwidth has been increased 250 megabits per second to a new total of one gigabit per second, the capacity of the second link. Because just the first tenant was initially allocated bandwidth on the second link, the network controller may merely increase the first tenant's initial bandwidth allocation to distribute the residual allocation that the first tenant lost on the first link.

In this example, the reduced bandwidth allocations for both the first and second tenants are the same, a 250-megabits per second reduction. The second tenant's residual bandwidth may be reallocated to another link that already has bandwidth allocated to the second tenant, an uncongested link, an under-allocated link, or combinations thereof. In this manner, both tenants may be fairly treated.

In some examples, the reduction may account for factors that result in an unequal distribution, but are intended to be fair when all material factors are considered. However, since the residual bandwidth allocations are distributed to other available links in the network, the tenants are not likely to be materially affected since they will both still receive their initial bandwidth allocation throughout the network.

In some examples, the bandwidth allocations are reduced by a substantially equal amount, a substantially equal proportion, a substantially equal percentage, an unequal amount, an unequal percentage, or combinations thereof. The bandwidth allocations and bandwidth capacity of the link may be measured in bits per time unit; in hertz, for those examples using wireless links; or other bandwidth measurements.

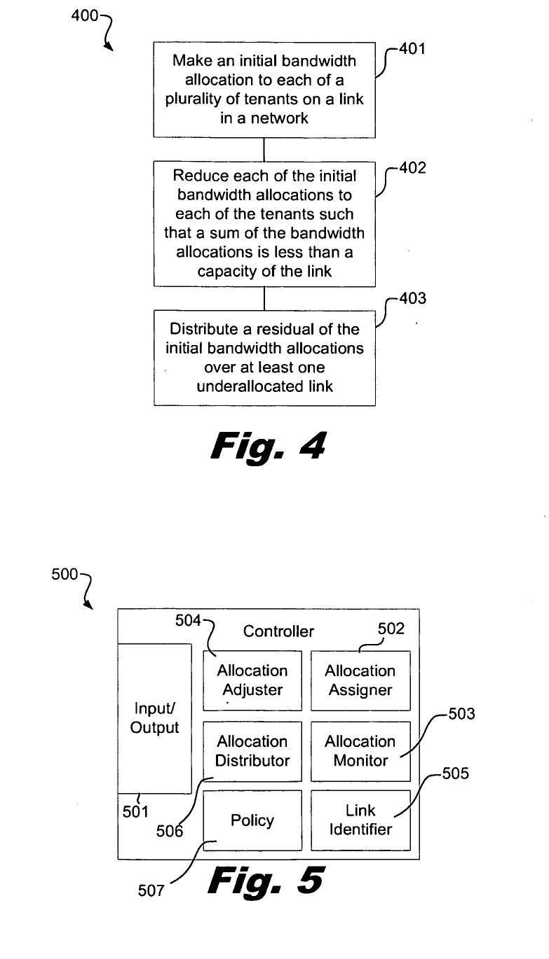

FIG. 4 is a diagram of an illustrative method (400) for allocating bandwidth according to principles described herein. In this example, the method includes making (401) an initial bandwidth allocation to each of a plurality of tenants on a link in a network, reducing (402) each of the initial bandwidth allocations to each of the tenants such that a sum of the bandwidth allocations is equal to or less than a capacity of the link, and distributing (403) a residual of the initial bandwidth allocations over at least one under-allocated link.

The method may also include monitoring the percentage of bandwidth usage on the link. Further, in some examples, the method also includes restoring the initial bandwidth allocations to the original link when the current allocations on the original link permit.

In some examples, the method also includes identifying links that already have bandwidth allocated to the tenants and increasing a bandwidth allocation for one of the tenants already allocated bandwidth on the at least one under-allocated link. In some examples, the method includes identifying uncongested links on the network and the at least one under-allocated link is an uncongested link. Further, in some examples, distributing the residual allocation includes distributing the residual to multiple links in the network in substantially equal amounts, substantially equal percentages, unequal amounts, unequal percentages, or combinations thereof.

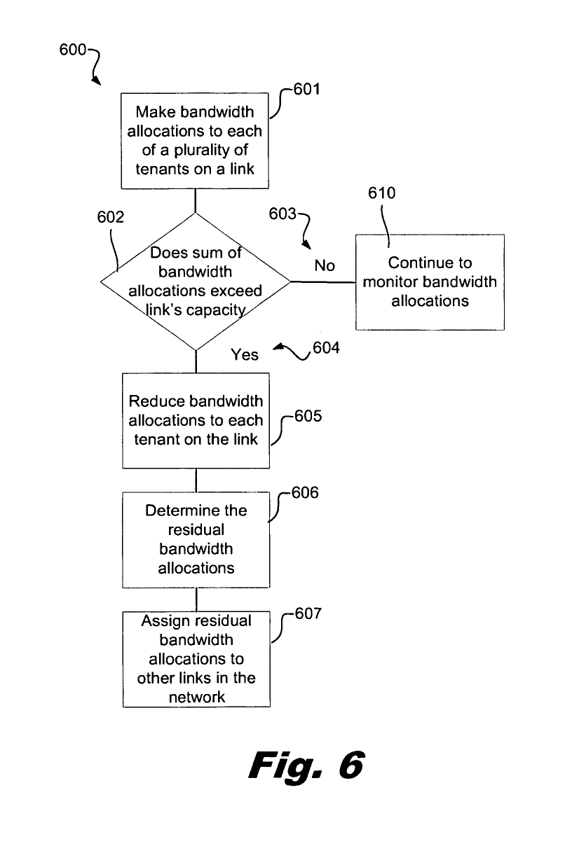

FIG. 5 is a diagram of an illustrative controller (500) for allocating bandwidth, according to principles described herein. In the example of FIG. 5, the controller (500) is responsible for allocating and directing traffic in the network.

In this example, the controller (500) has at least one input/output (501) to communicate with switches and other devices of the network. The controller may have an allocation assigner (502) that assigns initial bandwidth allocations to tenants on the links in the network. The controller (500) may also have an allocation monitor (503) that monitors how much bandwidth is allocated to each link. If the allocation monitor (503) detects that a link has an amount of bandwidth allocated to it that exceeds its capacity, an allocation adjuster (504) may restrict the bandwidth allocation per tenant on that link. After an allocation restriction has occurred, a link identifier (505) may identify links that are available to redistribute the residual allocations that the overwhelmed link lost. Once identified, an allocation distributor (506) may assign the residual allocations.

In some examples, the allocation distributor (506) and/or link identifier (505) follow a policy (507) that determines which links are under-allocated. In some examples, the policy (507) indicates that any link that has bandwidth allocated below its capacity is available. In other examples, a policy (507) indicates that available links are those that are uncongested or already have bandwidth allocated to a particular tenant. In some examples, the policy (507) instructs the link identifier (505) to prioritize different categories of links so that certain links are more likely to receive the residual allocation than others. For example, the policy (507) may include the link identifier (505) searching first for links that already have bandwidth allocated to the particular tenant whose traffic is being redistributed. If no under-allocated link can be found that already has bandwidth allocated to this tenant, then the policy (507) may include that the identifier (505) search for uncongested links. If no uncongested links are found, then the policy may include the next step of searching for any link with excess capacity.

A policy (507) may also govern prioritizing which tenants' residual allocations are reassigned first. In some examples, multiple links in the network have a sum of initial bandwidth allocations that exceed their capacity and the policy (507) governs which of the links to handle first. In some examples, the controller (500) has the capability to process the restriction and redistribution of each link's allocation simultaneously.

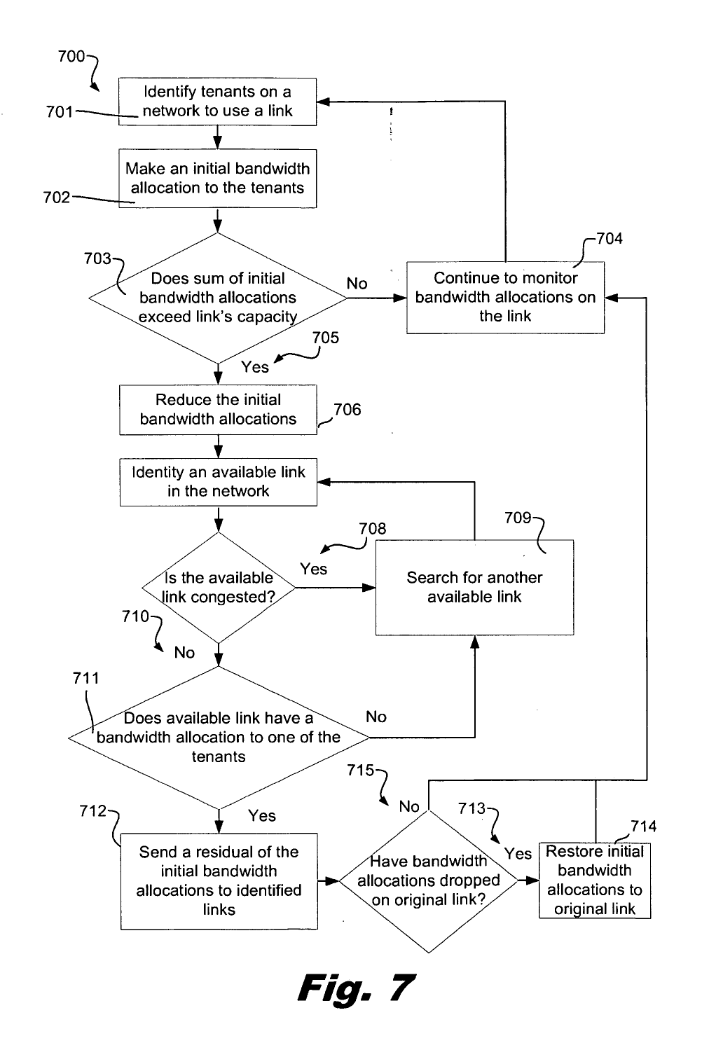

FIG. 6 is a diagram of an illustrative flowchart (600) for allocating bandwidth, according to principles described herein. A controller may make (601) bandwidth allocations to each of a plurality of tenants on a link. The controller may determine (602) if the sum of the bandwidth allocations exceeds the link's capacity. If not (603), the controller may continue (610) to monitor the allocations assigned to the link. If the link's capacity is exceeded (604), the controller may reduce (605) the bandwidth allocations to each tenant on the link. Next, the controller may determine (606) the residual bandwidth allocations that need to be assigned elsewhere in the network. Then the controller may assign (607) the residual bandwidth allocations to other links in the network.

FIG. 7 is a diagram of an illustrative flowchart (700) for allocating bandwidth, according to principles described herein. In this example, a controller identifies (701) tenants on a network to use a link, and the controller makes (702) initial bandwidth allocations to the tenants on that link. The controller may then determine (703) whether total bandwidth allocations assigned to the link exceed that link's capacity. If not, the controller may continue (704) to monitor the bandwidth allocations on the link. In this example, the controller will also identify (701) new links that need bandwidth allocations and execute the process for those new links.

If the controller determines (705) that the total bandwidth does exceed the link's capacity, the controller may reduce (706) the bandwidth allocations per tenant on that link. The controller may identify (707) links in the network that may receive the residual bandwidth allocations removed from the original link. If the controller identifies a link that it determines (708) is congested, the controller may search (709) for another link.

If the controller determines (710) that the link is under-allocated, the controller may also determine (711) if that link has a bandwidth allocation for a tenant that requires more bandwidth. If the controller determines that there is no under-allocated link that already has a bandwidth allocation for a tenant that requires more bandwidth, the controller may search for another available link (709). However, if the controller determines (712) that there is such a tenant, the controller may send at least a portion of the residual of the initial bandwidth allocation to the identified link.

After reallocating the bandwidth allocations, the controller may continue to monitor the allocations to the link. If the controller determines (713) that the bandwidth allocations on the original link have dropped below the link's capacity, the controller may restore (714) the original bandwidth allocation, or at least a portion thereof, to the original link. If the controller does not determine (715) that the demand for the link's bandwidth has dropped, the controller may continue (704) to monitor link.

In some examples, the controller dynamically determines to which under-allocated links a residual bandwidth allocation may be assigned. For example, the controller may know the bandwidth usage of other links, and when a bandwidth capacity is approached or exceeded, the controller may reroute the residual allocations to the most appropriate under-allocated link at that time. In other examples, the controller has a predetermined sequence of links to which it will automatically assign residual bandwidth. In some examples, a link is dedicated to picking up residual bandwidth allocations.

In some examples, the controller continues to monitor traffic from each of the traffic sources and/or tenants. In some examples, the controller adjusts the reduced bandwidth allocation to either increase or decrease the allocations depending on the circumstances.

In some examples, the links are made of tangible media that propagate signals between network devices, such as Ethernet or other cables. In some examples, at least one of the links is a wireless link that propagates the signal through space between a transmitter and receiver.

In some examples, the controller knows ahead of time when a bandwidth capacity is likely to be approached or exceeded and plans accordingly. For example, some of the network's traffic may occur as scheduled activities, and the controller may arrange ahead of time to ensure that certain links are available for the residual bandwidth demand beyond the capacity of an overwhelmed link. However, the controller may also be programmed to adjust the allocations as needed without foreknowledge of the tenants' and/or traffic sources' activities.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A method (400) for allocating bandwidth in a network, comprising:
making (401) an initial bandwidth allocation to each of a plurality of tenants on a link in a network;
reducing (402) each of said initial bandwidth allocations for each of said tenants such that a sum of said bandwidth allocations is equal to or less than a capacity of said link; and
distributing (403) a residual of said initial bandwidth allocations over at least one under-allocated link.

2. The method of claim 1, wherein distributing a residual of said initial bandwidth allocations over at least one under-allocated link includes identifying links that already have bandwidth allocated to said tenants and increasing a bandwidth allocation for one of said tenants already allocated bandwidth on said at least one under-allocated link.

3. The method of claim 1, further comprising restoring said initial bandwidth allocation to said link when said allocations permits.

4. The method of claim 1, wherein distributing a residual of said initial bandwidth allocations over at least one under-allocated link includes identifying uncongested links on said network and said at least one under-allocated link is an uncongested link.

5. The method of claim 1, wherein distributing a residual of said initial bandwidth allocations over at least one under-allocated link includes distributing said residual to multiple links in said network in substantially equal amounts.

6. The method of claim 1, wherein distributing a residual of said initial bandwidth allocations over at least one under-allocated link includes distributing said residual to multiple links in said network substantially proportional to said initial bandwidth allocations.

7. The method of claim 1, wherein distributing a residual of said initial bandwidth allocations over at least one under-allocated link includes identifying uncongested links that already have bandwidth allocated to at least one of said tenants and increasing a bandwidth allocation of said at least one tenant on one of said uncongested links.

8. A system for allocating bandwidth in a network (100), comprising:
a controller (112) in communication with a plurality of switches (104, 105), each switch being in communication with a plurality of network nodes;
said controller being programmed to:
identify tenants to use a link (113) within said network;
make an initial bandwidth allocation to each of said tenants on said link;
reduce each of said initial bandwidth allocations to each of said tenants such that a sum of said bandwidth allocations is equal to or less than a capacity of said link; and
distribute a residual of said initial bandwidth allocations to another link (114) in said network.

9. The system of claim 8, wherein said controller being programmed to distribute a residual of said initial bandwidth allocations to another link in said network includes identifying uncongested links that already have bandwidth allocated for at least one of said tenants and increasing a bandwidth allocation of said at least one tenant on one of said uncongested links.

10. The system of claim 8, wherein said controller being programmed to distribute a residual of said initial bandwidth allocations to another link in said network includes distributing said residual to multiple links in said network in substantially equal amounts.

11. The system of claim 8, wherein said controller being programmed to distribute a residual of said initial bandwidth allocations to another link in said network includes distributing said residual to multiple links in said network substantially proportional to said initial bandwidth allocations.

12. A computer program product, comprising:
a tangible computer readable storage medium, said computer readable storage medium comprising computer readable program code embodied therewith, said computer readable program code comprising:
computer readable program code to reduce an initial bandwidth allocation on a link (113) for a tenant in a network (100) so that a sum of multiple bandwidth allocations on said link is equal to or less than a capacity of said link; and
computer readable program code to distribute a residual of said initial bandwidth allocation to an under-allocated link (114) in said network.

13. A computer program product of claim 12, wherein said under-allocated link is an uncongested link.

14. A computer program product of claim 12, wherein said under-allocated link already has bandwidth allocated to said tenant.

15. A computer program product of claim 12, wherein said computer readable program code to distribute a residual of said initial bandwidth allocations over an under-allocated link in said network includes controlling at least one switch that directs traffic over said link.
